(19) United States
(12) Patent Application Publication
(10) Pub. No.: US 2025/0373033 A1
(43) Pub. Date: Dec. 4, 2025

(54) BATTERY DISCHARGE CONTAINMENT SYSTEM

(71) Applicant: Ascend Elements, Inc., Westborough, MA (US)

(72) Inventors: Gregory Davis, Westborough, MA (US); William D. Danielson, JR., Westborough, MA (US)

(21) Appl. No.: 19/228,113

(22) Filed: Jun. 4, 2025

Related U.S. Application Data
(60) Provisional application No. 63/655,857, filed on Jun. 4, 2024.

(51) Int. Cl. H02J 7/00; A62C 3/16; H01M 10/0525; H01M 10/44; H01M 10/48; H01M 10/613; H01M 10/63; H01M 10/6568; H01M 50/24

(52) U.S. Cl. CPC H02J 7/0029; A62C 3/16; H01M 10/0525; H01M 10/44; H01M 10/486; H01M 10/613; H01M 10/63; H01M 10/6568; H01M 50/24; H02J 7/0042; H02J 7/0047

(57) ABSTRACT

Disclosed is a battery discharge containment system and method for deenergizing a lithium-ion battery module or pack. The system comprises a discharge containment enclosure, an electrical discharge system, a temperature monitoring system, a coolant system, a fire protection system, and an optional exhaust system which operate together to quickly and safely deenergize a battery module or pack in preparation for recycling.

### RELATED APPLICATIONS

This patent application claims the benefit under 35 U.S.C. § 119 (e) of U.S. Provisional Patent App. No. 63/655,857, filed Jun. 4, 2024, entitled “BATTERY MODULE DISCHARGE CONTAINMENT,”

### BACKGROUND

Lithium-ion (Li-ion) batteries are a preferred chemistry for secondary (rechargeable) batteries in high discharge applications such as electric vehicles (EVs) and power tools where electric motors are called upon for rapid acceleration. Li-ion batteries include a charge material, conductive powder, and binder applied to or deposited on a current collector, typically a planar sheet of copper or aluminum. The charge material includes anode charge material, typically graphite or carbon, and cathode charge material, which includes a predetermined ratio of metals such as lithium, nickel, manganese, cobalt, aluminum, iron and phosphorous, defining a so-called “battery chemistry” of the Li-ion cells. Recycling of the Li-ion batteries recovers large amounts of charge material metals that would otherwise need to be provided from controlled sources, typically as a result of mining and refining.

### SUMMARY

A battery discharge containment system is described comprising a discharge containment enclosure for a Li-ion battery pack or module from an electric vehicle (EV) when the pack or module is being taken out of service due to age, capacity degradation, damage or other cause. The discharge containment enclosure includes access ports or fenestrations for discharge connections and also for systems configured for protection against combustion, explosion and gaseous discharge. The discharge connections emanate from a discharge controller operable to receive residual electrical energy from the battery pack or module for redistribution to the grid, such as by delivering a reverse voltage/current for a so-called “overdischarge” condition to render the battery inert. As the containment enclosure is sized to receive a full module or pack from the underside of the EV chassis, varying battery sizes of different manufacturer's vehicles are accommodated. The fenestrations of the containment enclosure facilitate electrical connections to the module or pack and/or also from a universal or adaptable discharge cable for connection to terminals on the module or pack.

Configurations herein are based, in part, on the observation that Li-ion batteries for EVs generally reside in a battery module contained within a battery pack that is mounted to the vehicle undercarriage and, as such, include a structured arrangement of large quantities of cathode and anode materials leading to positive and negative terminals. Recycling of Li-ion cells involves physically dismantling the battery modules or packs to obtain the individual battery cells therein for recycling, which usually involves crushing, shredding and grinding to generate a granular mass (i.e., a black mass) of the battery cell contents (cathodes, anodes, etc.).

Unfortunately, conventional approaches to Li-ion battery recycling suffer from the shortcoming that the battery modules and packs in the recycling stream have an unknown state of charge, depending on the donor vehicle, age, and last usage. Physical crushing and shredding of battery modules, packs and/or cells can trigger a sudden release of residual electrical energy, leading to an explosion or fire, sometimes referred to as thermal event. Accordingly, configurations herein substantially overcome the shortcomings of conventional battery recycling by providing a discharge containment system to quickly transfer residual electrical energy from a battery in a controlled and monitored manner to render the battery benign or inert while suppressing excess gaseous or exothermic reactions and invoking fire suppression via a flooding port in the unlikely event of excessive discharge. This enables a discharging process that is faster, safer, and more effective than can be done by other means, providing discharged packs or modules prior to physical dismantling, crushing, and shredding in anticipation of battery recycling.

As used herein, a battery pack is generally a battery-containing system attached or bolted to the vehicle underside and includes an internal array of modules comprising individual battery cells. Specific arrangements vary between manufacturers. Battery packs as well as battery modules removed from a battery pack can be positioned within the present containment enclosure for fast and effective discharging. Subsequent recycling produces a comingled granular mass of battery materials, including charge material metals, carbon and graphite, and current collectors such as aluminum and copper. The discharge process extracts residual electrical energy from the module to avoid sudden and unexpected release of residual energy during the recycling. The discharge containment system described herein provides an enclosed space in which positive and negative terminals of the module or pack can be electrically engaged and within which potential gaseous product formation, pressure buildup, and thermal events can be mitigated.

In further detail, configurations herein provide a battery discharge containment system comprising a discharge containment enclosure for deenergizing a lithium-ion battery module or pack. The discharge containment enclosure comprises an interior sized and shaped to receive the lithium-ion battery module or pack. The system further comprises an electrical discharge system configured to deenergize the lithium-ion battery module or pack while positioned within the interior of the enclosure, a temperature monitoring system configured to monitor the temperature of the interior of the enclosure during deenergizing, a coolant system configured to circulate a coolant to contact the lithium-ion battery module or pack during deenergizing while in the interior of the enclosure, a fire protection system configured to supply a fire suppressant to contact the lithium-ion battery module or pack during deenergizing while in the interior of the enclosure, and an optional exhaust system configured to remove gaseous products during deenergizing while in the interior of the enclosure.

In addition, configurations herein provide a method of deenergizing a lithium-ion battery module or pack comprising positioning the lithium-ion battery module or pack within an interior of a discharge containment enclosure of a battery discharge containment system that includes an electrical discharge system, a temperature monitoring system, a coolant system, a fire protection system, and an optional exhaust system. The method comprises engaging electrical contacts of the electrical discharge system to terminals of the battery module or pack and deenergizing the battery module or pack within the interior of the enclosure. Deenergizing may be terminated and a coolant from the coolant system can be directed to flow into the interior of the enclosure in response to a determination by the temperature monitoring system of an operating temperature above a temperature threshold during deenergizing. Coolant may also be provided during deenergizing in order to maintain a consistent operating temperature. Alternatively, or in addition, deenergizing may be terminated and a fire suppressant from the fire protection system can be directed to flow into the interior of the enclosure in response to a determination by the temperature monitoring system or the venting system of a thermal event occurring during deenergizing. Alternatively, or in addition, deenergizing may be optionally terminated and gaseous product removal from the interior of the enclosure can be increased by the venting system in response to a determination of a concentration of gaseous products above a threshold concentration during deenergizing. Optional venting may also be used throughout deenergizing to maintain a consistently low level of gaseous products.

### BRIEF DESCRIPTION OF THE DRAWINGS

The foregoing and other features will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles of the invention.

FIG. 1 is a context diagram of a battery recycling environment suitable for use with configurations herein;

FIG. 2 is schematic diagram of a discharge containment enclosure system suitable for use with configurations herein;

FIG. 3 is a perspective view of an embodiment of the discharge containment enclosure of the system of FIG. 2 showing capacity or volume for receiving a battery pack;

FIG. 4 is a length side elevation of an embodiment of the discharge containment enclosure of the system of FIG. 2 showing openings accessing the enclosure interior;

FIG. 5 is a top or plan view of an embodiment of the discharge containment enclosure of the system of FIG. 2; and

FIG. 6 is a width side elevation of an embodiment of the discharge containment enclosure of the system of FIG. 2.

### DETAILED DESCRIPTION

A method and system are herein described for safely and quickly discharging a lithium-ion battery module or pack to the low levels necessary for recycling. A containment enclosure equipped with an electrical discharge system, a temperature monitoring system, a coolant system, a fire protection system, and an optional exhaust system is used to discharge the module or pack with protection against an unexpected thermal event, such as a fire or explosion from a run-away discharge.

The disclosed approach employs an enclosure sized and shaped for a lithium-ion battery pack or module removed from an electric vehicle. Battery packs are formed of multiple batteries (cells) combined into modules via physical circuitry and connectors. While specific configurations may differ between manufactures, removing excess charge from packs or modules is preferable over individual batteries in order to minimize handling steps. The present battery discharge containment system includes a discharge containment enclosure that is configured to contain modules or packs of various sizes and styles, regardless of origin or manufacturer.

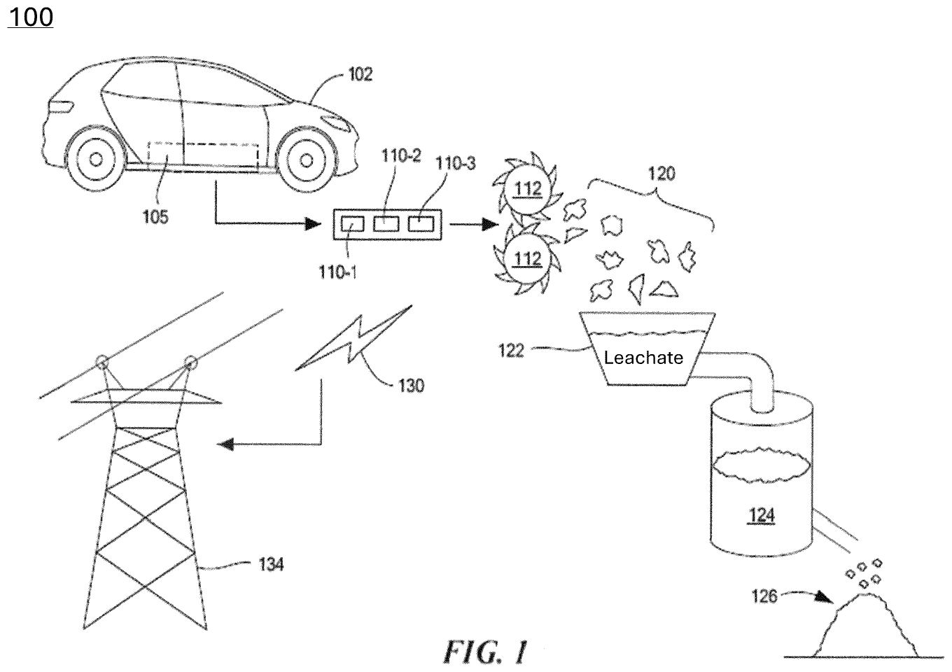

FIG. 1 is a context diagram of a recycling environment 100 suitable for use with configurations herein. Referring to FIG. 1, in a Li-ion battery recycling stream, end-of-life battery pack 105 is obtained from vehicle 102. The battery pack typically has a physical case shaped to attach to the underside of the vehicle according to manufacturer specifications and includes a plurality of interconnected battery modules 110-1 . . . 110-n (110 generally), often arranged to optimize placement and dimensions within battery pack 105. Modules 110, in turn, include an arrangement of interconnected cells. Typically, in order to provide a material suitable for recycling, battery pack 105, and modules 110 therein, are physically ground, shredded, and/or pulverized into granular assortment of battery ingredients 120, referred to as black mass. Black mass 120 contains the valuable battery materials for recycling, such as nickel, manganese, cobalt, aluminum, lithium and graphite, although any suitable battery chemistry can be employed. In order to be efficient, the black mass is formed using mechanically intensive processes such as using shredders (112), grinders, and/or other physical agitation techniques providing a randomness of contact with the materials in the battery packs. Due to the high energy density of the Li-ion battery, such contact can cause a sudden release of any excess residual electrical energy remaining in battery modules 110. In conventional processes, a sudden release of heat, gases and fire can be unpredictable and dangerous.

Once formed, black mass 120, which is a comingled combination of crushed battery components including cathode materials, anode materials, current collectors and casing materials, and a leach solution (such as an acidic water mixture) are combined to form leachate 122 containing the desirable charge material metals in a ratio that can be adjusted as needed, as disclosed in U.S. Pat. No. 9,834,827 and continuations thereof, incorporated by reference. Leachate 122 can then undergo coprecipitation reaction 124 to recover recycled cathode material precursor 126 (also referred to as pCAM or precursor Cathode Active Material), which is then sourced for new, recycled battery cells. Typically, the precursor is a hydroxide form of the metals discussed above, based on the battery chemistry of the individual cells of the packs or modules, which can vary within the recycling stream.

It is necessary to thoroughly discharge the battery modules or packs prior to forming the black mass in order to mitigate the risk of a sudden or uncontrolled release of residual electrical energy during grinding and shredding. The present disclosure provides a battery discharge containment system and a discharging method for safely and quickly removing excess energy in a battery module or pack in preparation for black mass formation.

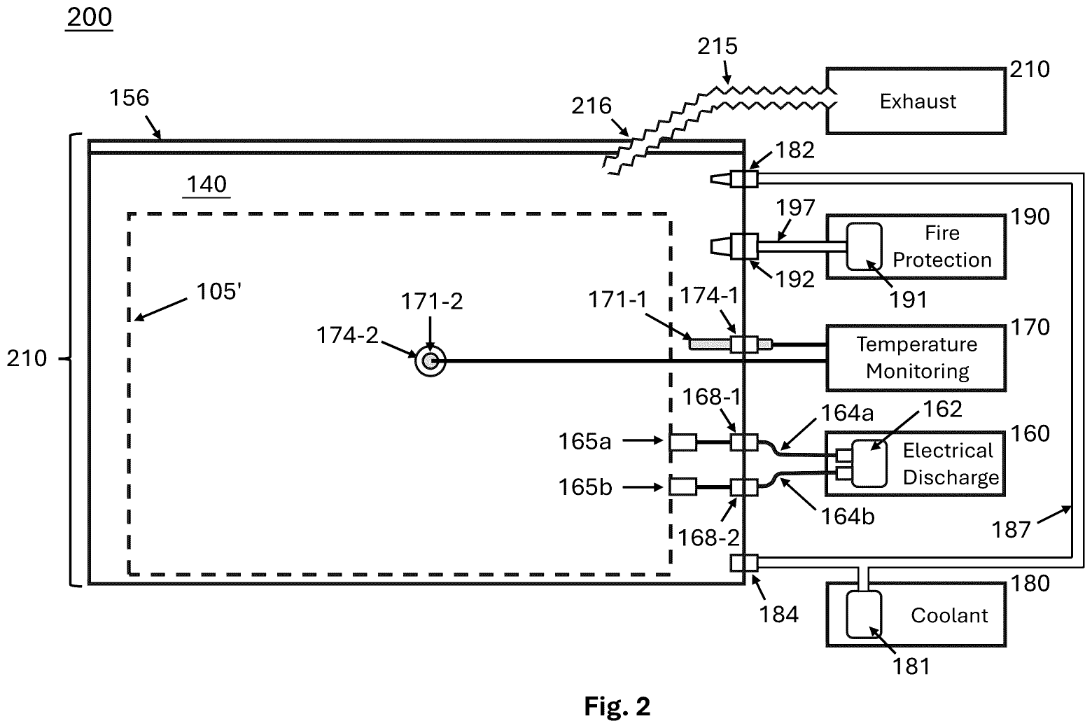

FIG. 2 is a schematic diagram of a battery discharge containment system suitable for use with configurations herein.

Referring to FIG. 2, containment system 200 for deenergizing a lithium-ion battery module or pack 105′ includes discharge containment enclosure 210 including interior 140 sized and shaped to receive and contain battery module or pack 105′. Note that battery module or pack 105′ may be shorter, taller, longer and/or wider than shown, thereby filling a different space within interior 140.

System 200 further includes electrical discharge system 160 configured to deenergize module or pack 105′ while positioned within interior 140 of the enclosure 210. The electrical discharge system includes a source of electrical energy 162 and electrical charging conduits 164a and 164b connecting terminals 165a and 165b of the battery module or pack and source of electrical energy 162. The electrical charging conduits may be cables or similar conductors having one end connectable to the source of electrical energy and a second end connectable to terminals of the battery module or pack. Discharge containment enclosure 210 includes one or more cable openings 168-1 . . . 168-2 (168 generally) positioned to provide electrical access to the battery module or pack by the electrical discharge system.

Electrical energy source 162 may be configured to apply a voltage load/drain or reverse voltage for forcing the battery cells in the module or pack to a safe or zero voltage level. In one configuration, the electrical source may be defined by a reverse voltage controlled as described in co-pending U.S. patent application Ser. No. 18/210,302, filed on Jun. 15, 2023, entitled “BATTERY CELL DISCHARGE SYSTEM AND METHOD OF DISCHARGING CELLS” and incorporated herein by reference in entirety. A reverse voltage may be applied to effectively force current through the anode and thus forcing the polarity to reverse, bringing the battery to a zero-energy state. The reverse polarity incurs short circuits resulting from degradation of current collectors in the battery, rendering it benign.

As also shown in FIG. 2, system 200 further engages with temperature monitoring system 170, configured to monitor the temperature of the interior of the enclosure during deenergizing, as well as with coolant system 180, which can be responsive to the temperature monitoring system and is configured to circulate a coolant to contact battery module or pack 105′ during deenergizing while in the interior of the enclosure. A paramount concern for battery module or pack discharge, and of Li-ion batteries in general, is thermal management of heat generated from the discharge process. A sufficient fluid transport into the enclosure would have the capacity for substantial thermal transfer to draw heat off the discharging battery 105′. Thermal management includes both temperature monitoring and coolant flow. Temperature monitoring system 170 includes at least one thermal sensor 172-1, 172-2 (172 generally) positioned to measure an operating temperature of the interior of the enclosure, particularly the surface temperature of the battery pack or module, and to communicate with coolant system 180, fire protection system 190, or both if the measured operating temperature is above a temperature threshold. The enclosure 210 includes complementary openings 174 positioned to provide thermal access to the interior of the enclosure. For example, thermal access may be provided through openings 174-1 and/or 174-2 to determine the operating temperature in the center of the enclosure. IR, thermocouple, resistance or similar sensing mediums may be employed, and opening 174 enables insertion or sensing into the interior of the enclosure.

Coolant passages 182, 184 for inflow and outflow (drain), respectively, provide an interface for exchange of cooling fluid. Suitable connections to a coolant and recirculation of the coolant from a supply of coolant (typically water or a water solution) are provided to establish a flow of cooling fluid. The coolant system 180 includes coolant supply 181 and coolant conduit 187 connecting the coolant supply to the interior of the enclosure. Coolant passages 182, 184 are positioned to provide fluid access to the interior of the enclosure and the module or pack within. Generally, coolant flow into the enclosure through coolant passage 182 is towards the top of the enclosure, to quickly quench a thermal runaway, while flow of the coolant out from the enclosure through coolant passage 184 is towards the bottom of the enclosure to efficiently drain the used coolant.

System 200 further includes fire protection system 190 configured to supply a fire suppressant to contact the lithium-ion battery module or pack during deenergizing while in the interior of the enclosure. While the coolant fluid may generally be water or a water mix which provides substantial temperature reduction, fire protection system 190 provides a voluminous deluge of a fire suppressant in the event of a sudden runaway discharge, overheating or other sudden exothermic reaction. Any fire suppressant capable of flowing into the interior of the enclosure may be used. Thus, fire protection system 190 includes fire suppressant supply 191 and suppressant conduit 197 connecting the fire suppressant supply to the interior of the enclosure and may access the interior through opening 192 in the enclosure. Any suitable opening positioned to provide fluid access to the interior of the enclosure may be employed for fire prevention system 190, preferably of a substantial cross section to provide a significant flow of fire suppressant from the fire suppressant supply quickly into interior 140 of enclosure 210.

In some configurations, fire protection system 190 may integrate with the coolant system 180 by providing a sudden and complete volume of a liquid coolant (such as water) into the entire interior rather than a cyclic flow of the liquid coolant. Alternative, or in addition, the fire protection system may rapidly supply a non-liquid suppressant such as carbon dioxide or similar noncombustible substance.

A sufficiently large enclosure 210 for containing the module or pack 105′ coupled with the subsystems for discharge 160, temperature 170, cooling 180, fire protection/suppression 190 and venting 200 is a symbiotic arrangement that localizes a hazardous phase of the module or pack 105′ prior to recycling, and then establishes appropriate safeguards at that hazardous phase, allowing more relaxed handling downstream.

System 100 optionally further comprises exhaust system 210 configured to remove gaseous products from the interior of the enclosure during deenergizing, which may be positioned in a lid or side of the enclosure. Reactions occurring in Li-ion batteries can produce gaseous byproducts such as hydrogen and hydrogen fluoride as well as volatile and reactive components from battery electrolytes, which can be in harmful or hazardous concentrations during an accelerated discharge. A ventilation or exhaust system may include a vent pump and a venting conduit, such as conduit 215, connecting the interior of the enclosure through vent opening 216 in lid 156. The lid may be used to further enclose the module or pack, providing a more stable internal environment and protecting it from exposure to dust or debris. Gaseous products may be vented to an external exhaust system, suitably equipped with environmental protections, to safely remove gaseous products from the interior of the enclosure.

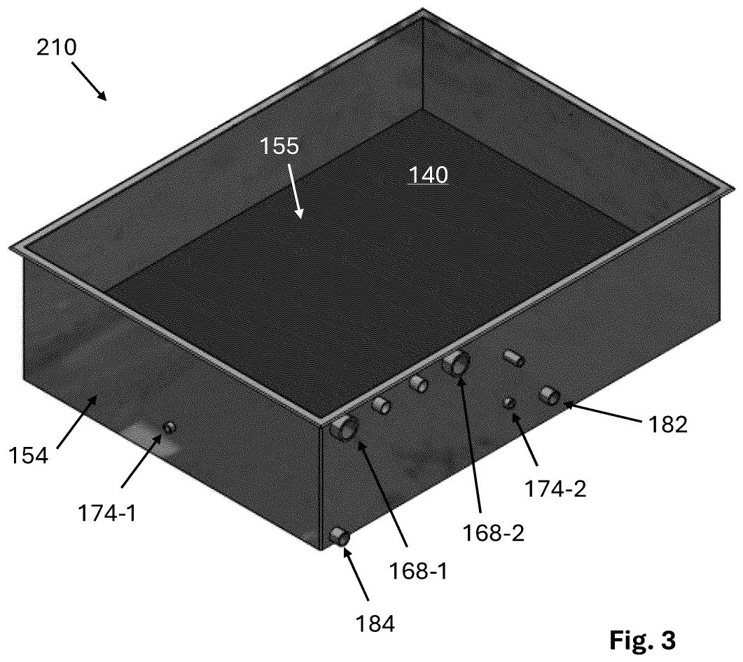

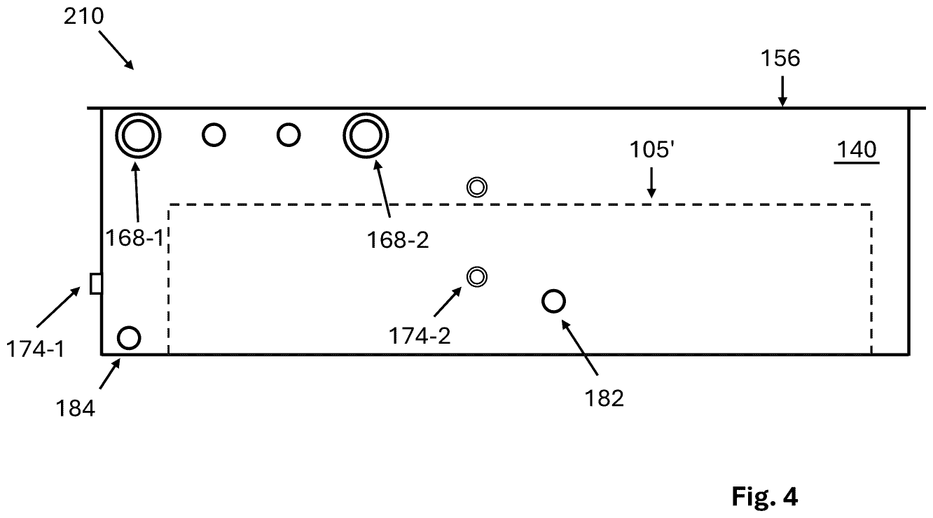

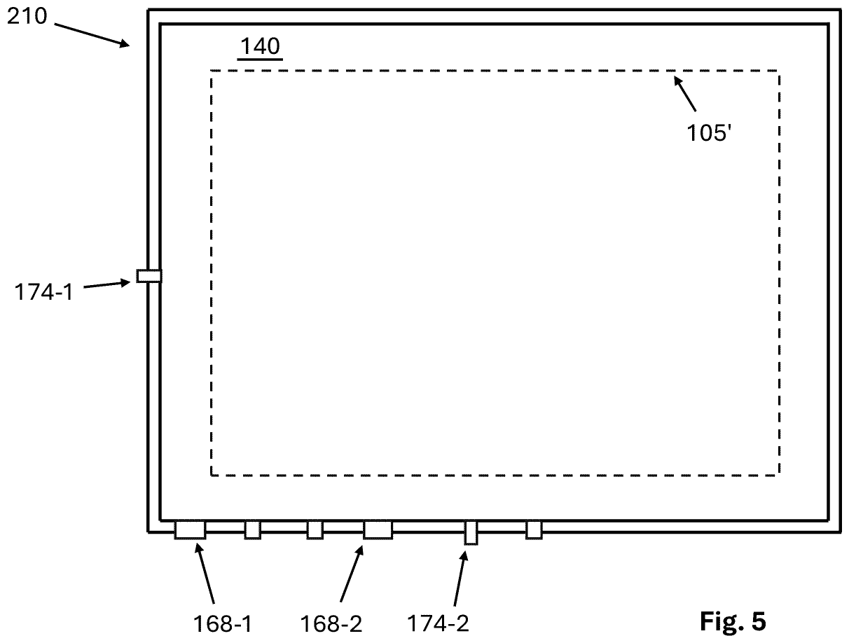

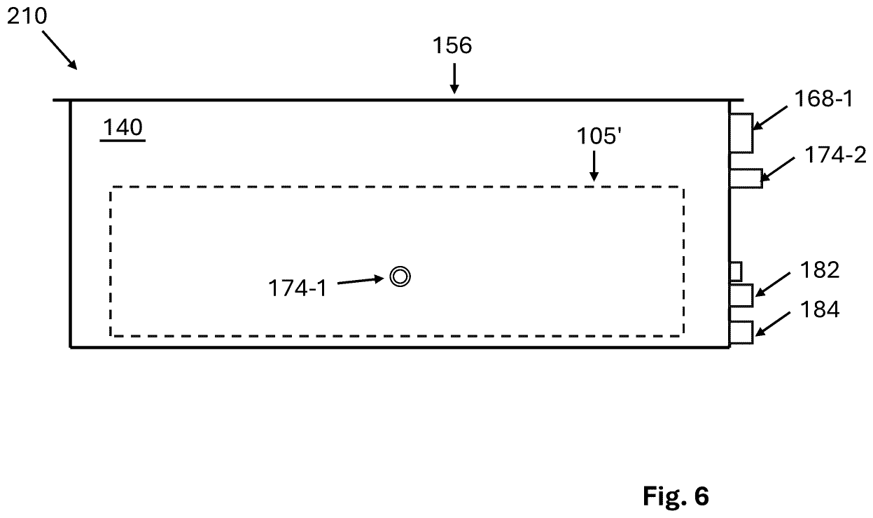

FIG. 3-6 are various views of a specific embodiment of the discharge containment enclosure depicted in FIG. 2. In particular, FIG. 3 is a perspective view, FIG. 4 is a length side elevation view, FIG. 5 is a top or plan view, and FIG. 6 is a width side elevation of the enclosure of shown in FIG. 2, each showing particular locations of the access conduits used by the electrical discharge system, the temperature monitoring system, the coolant system, the fire protection system, and the optional venting system described above. For this specific embodiment of the discharge containment system, enclosure 210 includes a horizontal bottom 155, four vertical sides 154-1 . . . 154-4 (154 generally), and an optional securable horizontal lid 156 forming interior 140 of the enclosure, wherein at least one of the vertical sides includes the one or more openings configured to provide access to the enclosure interior for the electrical discharge, temperature monitoring, coolant, fire prevention, and exhaust systems. Openings may also be positioned in the horizontal bottom, such as a drain, and/or the optional securable horizontal lid, such as a vent. The temperature monitoring system may need only thermal communication, such as through one of the vertical sides 154, or an infrared (IR) lens for IR based sensing. As shown in these figures, complete containment of a battery module or pack allows rapid discharge to a safe level prior to any shredding or other recycling operations.

The battery discharge containment system of the present disclosure enables a method of deenergizing a battery module or pack, such as a lithium-ion battery module or pack. The method comprises positioning the lithium-ion battery module or pack within an interior of a discharge containment enclosure a battery discharge containment system. The system includes an electrical discharge system, a temperature monitoring system, a coolant system, a fire protection or suppression system, and an optional exhaust or venting system. The interior of a discharge containment enclosure may be enclosure 210 of battery discharge containment system 200, discussed above, and the electrical discharge system, temperature monitoring system, coolant system, fire protection or suppression system, and exhaust or venting system may be systems 160, 170, 180, 190, and 195 respectively, as also discussed above.

The method further comprises engaging electrical contacts of the electrical discharge system to terminals of the battery module or pack, and deenergizing the battery module or pack within the interior of the enclosure. In operation, electrical contacts of the electrical discharge system can be engaged to terminals of the battery module or pack using a set of electrical cables with clamps or lugs that may be employed to reach into the interior of the enclosure and connect to the battery module or pack. Once the cables are connected, the electrical discharge system deenergizes the battery module or pack securely contained within the interior of the enclosure.

During discharge, the various systems monitor and react to ensure safety is maintained. For example, deenergizing is terminated and a coolant from the coolant system is directed to flow into the interior of the discharge enclosure in response to a determination by the temperature monitoring system of an operating temperature above a temperature threshold during deenergizing. Alternatively, or in addition, deenergizing is terminated and a fire suppressant from the fire protection system is directed to flow into the interior of the discharge enclosure in response to a determination by the temperature monitoring system or the venting system of a sudden thermal event, fire or explosion occurring during deenergizing. Alternatively, or in addition, deenergizing is terminated and optionally gaseous product removal from the interior of the discharge enclosure is increased by the venting system in response to a determination of a concentration of gaseous products above a threshold concentration during deenergizing.

The method and system of the present disclosure overcome significant deficiencies of currently known processes. For example, one well-established method is a solution discharge technique in which a battery pack or module is submerged in a large tank, tub or similar container holding a chemically treated water, such as a brine solution. The battery module or pack is cut to access the electrolyte within and then soaked in the solution. This technique is considerably time-consuming and also requires a large amount of space to scale in order to handle multiple units. Further, the battery must be physically cut to expose the electrolyte. Another technique is a resistor discharge in which a load resistor is connected across the terminals of the battery module or pack, which converts the electrical energy into thermal energy, essentially heating up the resistor. This is also very time-consuming since the load is passive. The third method is an electrical discharge approach in which energy is removed from the battery pack or module, typically using available standard loads to deenergize the system. This inverts common charging polarity-instead of adding energy to a device/battery to add charge, energy is removed from it.

The disclosed discharge containment system and method allows the discharge of batteries faster than conventional approaches since the impact of a rare thermal event is limited to the contents of the enclosure and is mitigated by the associated systems. Standard practice in the recycling industry is to follow conservative discharge rates to minimize the chance of a thermal event and the damage it could cause. However, this dramatically reduces the throughput of materials for recycling, which benefits from fast, safe, and effective discharge. Safe and efficient deenergizing of batteries is accomplished using the present method and system by securing a battery pack or module within an enclosure that allows a fire extinguishing agent such as water, to flood over the battery and contain and terminate a thermal event including overheating, electrolyte venting, smoke or fire. Sensors monitor the discharge process and detect dangerous temperatures, automatically responding by curtailing battery discharge and commencing the flow of the fire suppression agent if needed. An exhaust duct on the discharge enclosure may remove electrolyte fumes to prevent an explosion and/or smoke in case of a fire. A battery cooling system can be utilized to maintain the battery at a safe temperature while discharging at a high rate. This system expedites battery de-energization at higher-than-normal discharge rates since the enclosure will prevent harm to personnel or the facility if an unusual circumstances cause a thermal event to occur.

In addition, discharge rates can be safely increased because the discharge voltage can be manipulated through a recipe in a discharging profile, drawing a large amount of current initially and then gradually reduces the current as a function of time. In this way, when there is a reduced amount of energy in the unit, less energy is being removed through the current. This helps to maintain a steady temperature of the battery module or pack during discharge. If discharging occurs too quickly, the charge material can quickly heat up, which can induce a thermal runaway.

Thus, the present battery discharge containment system provides a secure interior in which a battery module or pack is safely contained, and the disclosed method allows discharge faster than conventional discharge approaches because discharge variables and conditions within the enclosure are closely monitored and, if necessary, can be quickly terminated by the various systems, thereby allowing a higher, but not undue, risk profile. As an additional advantage, the energy that is discharged from the module or pack can be converted back to AC which can be fed through a local grid connection, also referred to as a regenerative discharge.

It should be apparent that battery discharge containment system and method provide a comprehensive and complementary arrangement of monitoring and responsive systems for safely and effectively managing the deenergizing of battery modules or packs, often having an unknown history and state of charge.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A battery discharge containment system for deenergizing a lithium-ion battery module or pack comprising:
a discharge containment enclosure having an interior sized and shaped to receive the lithium-ion battery module or pack,
an electrical discharge system configured to deenergize the lithium-ion battery module or pack while positioned within the interior of the enclosure,
a temperature monitoring system configured to monitor a temperature of the interior of the enclosure during deenergizing,
a coolant system configured to circulate a coolant to contact the lithium-ion battery module or pack during deenergizing while in the interior of the enclosure,
a fire protection system configured to supply a fire suppressant to contact the lithium-ion battery module or pack during deenergizing while in the interior of the enclosure, and
an optional exhaust system configured to remove gaseous products during deenergizing while in the interior of the enclosure.

2. The battery discharge containment system of claim 1, wherein the electrical discharge system comprises a source of electrical energy and an electrical charging conduit connecting the battery module or pack and the source of electrical energy.

3. The battery discharge containment system of claim 2, wherein the electrical discharge system further comprises an electrical storage device and an electrical storage conduit connecting the battery module or pack to the electrical storage device.

4. The battery discharge containment system of claim 2, wherein the electrical charging conduit is a cable having a first end connectable to the source of electrical energy and a second end connectable to terminals of the battery module or pack.

5. The battery discharge containment system of claim 3, wherein the electrical storage conduit is a cable having a first end connectable to terminals of the battery module or pack and a second end connectable to the electrical storage device.

6. The battery discharge containment system of claim 1, wherein the enclosure comprises at least one opening positioned to provide electrical access to the battery module or pack by the electrical discharge system.

7. The battery discharge containment system of claim 1, wherein the temperature monitoring system comprises at least one thermal sensor positioned to measure an operating temperature of the interior of the enclosure and to communicate with the coolant system, the fire suppression system, or both if the measured operating temperature is above a temperature threshold.

8. The battery discharge containment system of claim 7, wherein the enclosure comprises at least one opening positioned to provide thermal access to the interior of the enclosure.

9. The battery discharge containment system of claim 8, wherein the at least one opening enables insertion of a thermal sensor into the interior of the enclosure.

10. The battery discharge containment system of claim 1, wherein the coolant system comprises a coolant supply and a coolant conduit connecting the coolant supply to the interior of the enclosure.

11. The battery discharge containment system of claim 10, wherein the enclosure comprises at least one opening positioned to provide fluid access to the interior of the enclosure.

12. The battery discharge containment system of claim 11, wherein the at least one opening enables flow of coolant from the coolant supply into the interior of the enclosure.

13. The battery discharge containment system of claim 1, wherein the fire protection system comprises a fire suppressant supply and a suppressant conduit connecting the fire suppressant supply to the interior of the enclosure.

14. The battery discharge containment system of claim 13, wherein the enclosure comprises at least one opening positioned to provide fluid access to the interior of the enclosure.

15. The battery discharge containment system of claim 14, wherein the at least one opening enables flow of a fire suppressant from the fire suppressant supply into the interior of the enclosure.

16. The battery discharge containment system of claim 1, wherein the exhaust system comprises at least one vent pump and a venting conduit connecting the interior of the enclosure to the vent pump to remove gaseous products from the interior of the enclosure.

17. The battery discharge containment system of claim 1, wherein the enclosure comprises a horizontal bottom, four vertical sides, and an optional securable horizontal lid forming the interior of the enclosure, and wherein at least one vertical side comprises one or more openings configured to provide access to the enclosure interior.

18. The battery discharge containment system of claim 17, wherein one or more of the openings are positioned to provide fluid access to the interior of the enclosure.

19. The battery discharge containment system of claim 17, wherein one or more of the openings are positioned to provide thermal access to the interior of the enclosure.

20. A method of deenergizing a lithium-ion battery module or pack comprising:
positioning the lithium-ion battery module or pack within an interior of a discharge containment enclosure of a battery discharge containment system, the system comprising an electrical discharge system, a temperature monitoring system, a coolant system, a fire protection system, and an optional exhaust system,
engaging electrical contacts of the electrical discharge system to terminals of the battery module or pack, and
deenergizing the battery module or pack within the interior of the enclosure, wherein
i) deenergizing is terminated and a coolant from the coolant system is directed to flow into the interior of the enclosure in response to a determination by the temperature monitoring system of an operating temperature above a temperature threshold during deenergizing,
ii) deenergizing is terminated and a fire suppressant from the fire protection system is directed to flow into the interior of the enclosure in response to a determination by the temperature monitoring system or the venting system of a thermal event occurring during deenergizing, or
iii) optionally deenergizing is terminated and gaseous product removal from the interior of the enclosure is increased by the venting system in response to a determination of a concentration of gaseous products above a threshold concentration during deenergizing.
